(19) United States
(12) Patent Application Publication
(10) Pub. No.: US 2021/0309039 A1
(43) Pub. Date: Oct. 7, 2021

(54) FORGE-PROOF DOCUMENT

(71) Applicant: IAI industrial systems B.V., Veldhoven (NL)

(72) Inventor: Niels Michel Antoon Janssen, Bladel (NL)

(21) Appl. No.: 17/265,122

(22) PCT Filed: Jul. 10, 2019
(86) PCT No.: PCT/EP2019/068493

§ 371 Date: Feb. 1, 2021

(30) Foreign Application Priority Data
Aug. 10, 2018 (EP) 18188521.1

(51) Int. Cl. B42D 25/346; B42D 25/435; B42D 25/29; B42D 25/387

(52) U.S. Cl. CPC B42D 25/346; B42D 25/387; B42D 25/29; B42D 25/435

(57) ABSTRACT

The present invention relates to a forge-proof document comprising: a front side, a back side, a first security feature comprising a perforation pattern which displays a first image information when viewed against a bright background, and a second security feature comprising a pattern which displays a second image information when light falling on the pattern is reflected, wherein the first and the second image information to be displayed on the forge-proof document correspond with each other, wherein the front side comprises the second security feature, wherein the back side comprises the second security feature, and wherein the second image information of the back side is the mirrored image information of the second image information of the front side.

### CROSS-REFERENCE TO RELATED APPLICATION(S)

This application is a national stage application of International PCT Appl. No. PCT/EP2019/068493, titled “Forge-Proof Document,” filed Jul. 10, 2019, which claims priority to European Appl. No. 18188521.1, filed Aug. 10, 2018, each of which is hereby incorporated herein by reference in its entirety.

### BACKGROUND OF THE DESCRIPTION

The present invention relates to a forge-proof document.

Such a forge-proof document is known, e.g., as banknotes or identity cards, which have, e.g., water marks or the like.

Further, known forge-proof documents comprise a security hologram which is applied on a side of a document, such as a passport or a banknote.

Although the prior art provides a good security against forgery, it is important to develop new security features in respect of the technical potential of forgers.

Thus, it is an object of the present invention to provide a forge-proof document having security features enhancing the security against forgery and counterfeiting to complicate copying of documents, such as passports or tickets.

### SUMMARY

To solve the mentioned object, the following explanations can be used.

According to an aspect of the present invention, an inventive forge-proof document comprises a front side and a back side.

In general, the inventive forge-proof document can be a badge, an ID card, a datapage card in a passport or any other type of document which should be forge-proof, such as, e.g., a ticket for a soccer game or a driving license or a residence card.

Preferably, the forge-proof document includes a first security feature comprising a perforation pattern which displays a first image information when viewed against a bright background. Such a perforation pattern is preferably applied by means of laser light. This measure has the advantage that at the position of the perforation the material, for instance paper, plastic or textile, is completely removed, so that when, for instance, the fingertips brush over the document no elevation or channel or burr can be felt at all. If, for instance, a perforation pattern were to be applied by forgers by means of, for instance, conically formed needles, cup-shaped edges or burrs are always created, which are easily discernible with the fingertips. This, therefore, provides a good means of identifying possible forgeries.

Further, it is preferred that the forge-proof document includes a second security feature comprising a pattern which displays a second image information when light falling on the pattern is reflected. Such a security feature can be made, e.g., by laser engraving, which is the practice of using lasers to engrave an object, or by inkjet printing or by laser printing.

Advantageously, the first and the second image information to be displayed on the forge-proof document correspond with each other. Thus, on the back and on the front side corresponding information can be applied which, e.g., facilitate validating the authenticity of the forge-proof document. In this context, e.g., it will become easier for a border official or another person to validate such a forge-proof document and at the same time make it harder for forgers to copy.

Further, it is advantageous that the front side comprises the second security feature, wherein preferably the back side also comprises the second security feature. Thus, the forge-proof document preferably comprises the first security feature (perforation pattern) visible on the front and on the back side as well as a front side having the second security feature and a back side also having a second security feature.

It is further preferred that the second image information of the back side is the mirrored image information of the second image information of the front side.

Thus, when holding the inventive forge-proof document up to the light so that, e.g., daylight or light of a light source can shine through the perforation pattern, a person looking on the front side sees two images and image information, namely the first and the second image information. On the front side, the first and the second image correspond to each other and represent, e.g., a passport photograph of a person.

Further, when holding the inventive forge-proof document up to the light so that, e.g., daylight or light of a light source can shine through the perforation pattern, a person looking on the back side also sees two images and image information, namely the first and the second image information. On the back side, the first and second image information are identical and represent, e.g., also a passport photograph of a person.

However, the second image information of the front side and the back side are different. The image information on the back side is mirrored in comparison to the image information on the front side.

Summarizing the above, if viewed on the back side of the forge-proof document, the first image information of the first security feature is observable, and the same applies if viewed on the front side.

However, due to the fact that the first security feature partially and/or completely penetrates the forge-proof document with its perforations, the observable first image information on the back side is the mirrored image information of the observable first image information on the front side.

Thus, all the image information on the back side which can be observed by a person is the mirrored image information of the front side which can be observed by a person.

Again, in other words, all the observable image information on the back side is the horizontally mirrored image information of the observable image information on the front side.

Due to this unique arrangement, a person or a border official looking on the front side of the inventive forge-proof document sees at the same time, e.g., a normal passport photograph as a picture on or within the forge-proof document and the same passport photograph as a perforated photo.

And, a person or a border official looking on the back side of the inventive forge-proof document sees at the same time, e.g., a normal passport photograph as a picture on or within the forge-proof document and the same passport photograph as a perforated photo.

But, the two photos and image information of the back side are mirrored comparing to the photos and image information, respectively, on the front side.

Summarizing the invention again, the perforation pattern of the first security feature is applied only once to the forge-proof document and can be observed on the front and on the back side. This perforation pattern corresponds to and matches with the pattern of the second security feature on the front and on the back side.

Thus, if the first security feature which has the perforation pattern and which is visible from the front and the back side corresponds to and matches with the pattern of the second security feature on the front and on the back side, the document (e.g., passport) can be considered to be authentic. Hence, counterfeiting, e.g., a passport, is extremely difficult.

It is further preferred that the second security feature comprises an engraved pattern which displays a second image information when light falling on the engraved pattern is reflected.

Additionally or alternatively, it is preferred that the second security feature comprises an inkjet printed pattern which displays a second image information when light falling on the printed pattern is reflected.

It is also additionally or alternatively possible that the second security feature comprises a laser printed pattern which displays a second image information when light falling on the printed pattern is reflected.

Further, it is advantageous that on the back side, the second image information represented by the second security feature is identical to the first image information represented by the first security feature. Thus, there is no difference in the informative content.

Preferably, on the back side, the first and second image information of the corresponding security features coincide. This enhances the security against counterfeiting as, e.g., a passport is only authentic if the passport photograph as well as the first image information and the second image information on the back side show the identical image information.

It is a further advantage that this coincided arrangement can easily be controlled by holding the forge-proof document up to the light to check that the first image information comprising the perforation pattern is in line and aligned with the second image information.

Thus, two photos which are made different, namely by perforation and by engraving or by laser printing or by inkjet printing, and which lie on top of each other and coincide, show the identical photo in the same space and position of the forge-proof document, but in two different ways.

Hence, a user or person sees at the same time the reflected picture made by engraving or by laser printing or by inkjet printing and a picture shined through by light made by perforation.

It is also possible that on the front side, the second image information represented by the second security feature corresponds to the second image information on the back side. Thus, all images created on the forge-proof document show the same image and the same informative content.

Further, it is possible that on the front side, the first and second image information of the corresponding security features coincide. This means that the second image information of the second security feature on the front side and the first image information of the first security feature are in line and aligned or lie on top of each other and coincide.

Further, it is preferred that the second image information of the front side coincides with the second image information of the back side and with the first image information of the forge-proof document.

Hence, the first security feature which can be seen on the front and back sides of the forge-proof document is aligned and coincides with the second image information of the second security feature applied on the front and back sides.

In other words, it is preferred that a second image information having a pattern on the front side coincides with a second image information having a pattern on the back side, wherein the image information of the back side is the mirrored image information of the front side. It is also preferred that a first image information having a perforated pattern is made such that this image information and pattern coincides and is aligned with the second image information on the front and back sides.

Thus, the three image information coincide, namely the two image information of the second security feature on the front and back sides and the patterned image information within the forge-proof document, wherein the image information of the second security feature is only visible on the front or on the back side, and wherein the patterned image information is visible on the front and on the back sides.

It is a further advantage that the second image information of the front side comprises a greater or smaller size on the document than the second image information of the back side. Thus, the image information can be magnified on the front size in comparison to the back side so that the forge-proof document can easily be compared, e.g., to the human being depicted on the forge-proof document.

Preferably, the size of the second image information of the back side and the size of the first image information are identical. This allows an easy comparison of the two image information of the forge-proof document.

Moreover, it is advantageous that the front side comprises the second security feature having a pattern of a first printing technique and preferably the back side comprises the second security feature having a pattern of a second printing technique.

In this context, it is preferred that the first and second printing technique differ from each other. Preferably, the first printing technique comprises laser engraving, inkjet printing or laser printing, and advantageously, the second printing technique comprises laser engraving, inkjet printing or laser printing.

Thus, it is possible that the first printing technique comprises laser engraving and the second printing technique comprises inkjet printing or laser printing.

Further, it is preferred that the pattern of the second security feature displays a second image information when light falling on the pattern is reflected.

It is also preferred that the forge-proof document comprises the first security feature having a perforation pattern which displays a first image information when viewed against a bright background.

Preferably, the forge-proof document also comprises the second image information made by a first printing technique on the front side and the second image information made by a second printing technique on the back side.

Advantageously, the second image information correspond to the first image information, and the second image information of the back side is the mirror image information of the second image information of the front side.

Summarizing the above, it is preferred that a forge-proof document is characterized in that:
the front side comprises a second security feature having a pattern which displays a second image information when light falling on the pattern is reflected;
preferably, the back side comprises a second security feature having a pattern which displays a second image information when light falling on the pattern is reflected;
preferably, the forge-proof document comprises a first security feature having a perforation pattern which displays a first image information when viewed against a bright background;
preferably, the second image information of the front and back side corresponds to the first image information; and
preferably, the second image information of the back side is the mirror image information of the second image information of the front side.

However, due to the fact that the first security feature partially and/or completely penetrates the forge-proof document with its perforations, the observable first image information on the back side is the mirrored image information of the observable first image information on the front side.

Thus, all the image information (first and second image information) of the back side which can be observed by a person is the mirrored image information (first and second image information) of the front side which can also be observed by a person.

According to a further aspect of the present invention, preferably, the perforation pattern and the first image information are a representation of an image and the second image information is arranged on the document by means of a different technique, such as engraving an engraved pattern, laser printing a laser printed pattern, or inkjet printing an inject printed pattern.

Owing to the possibility of visually comparing the image (second image information) and the perforation (first image information), without the deployment of complicated assist means being required, a less than perfect forgery of just one of the two becomes immediately recognizable. A high degree of security against fraud is thus obtained.

This measure preferably requires that, in order to make such a document, there must be present means for making the perforation pattern (first image information), means for making the associated image with a different technique, and means for recording a template and putting it into digital form to enable control of the means necessary for making the perforation pattern.

An important application of the present invention lies in the fact that the document is a passport and that the template is a passport photograph.

Advantageously, the document to be protected against forgery comprises a first security feature in the form of a perforation pattern, wherein the perforation pattern extends over a surface of the forge-proof document and represents an image comprising brightness tones.

It is also preferred that the image and the first image information are visible when the document is illuminated from the rear.

Advantageously, the perforation pattern and the first image information are applied by means of laser light.

Preferably, the perforation pattern is a representation of a second image information and image arranged on the document by means of a different technique, wherein preferably, the second image information arranged by means of a different technique is specific to the document.

It is further preferred that the document is a passport and that the second image information is a passport photograph, wherein preferably the first security feature is applied on a page of the passport other than the page on which the passport photograph is arranged. Alternatively, it is possible that the document is a passport and that the second image information is a passport photograph, wherein preferably the first security feature is applied on a front or back side of the passport on which the passport photograph is arranged.

It is a further advantage that the brightness tones of the first image information are represented by means of the size of the perforations.

Further, it is advantageous that the brightness tones are represented by means of the density of the perforations.

It is also preferred that the light tones are represented by large perforation holes or a high density of perforation holes and that dark tones are represented by small perforation holes or a low density of perforation holes.

It is pointed out that the invention preferably also relates to a method for applying a security feature in the form of a perforation pattern in a document.

More precisely, it is preferred that a method for applying a first security feature in the form of a perforation pattern in a document comprises that the perforation pattern is applied by a laser device which is adapted to successively apply the perforation pattern in the document, wherein the size of the perforation holes or the density of the perforation holes is controlled by means of an electronic representation of the image.

It is also preferred that the document is a passport and that a perforation pattern and the first image information applied in the passport are a representation of the passport photograph arranged in the passport.

Advantageously, the passport photograph and image information are put into digital form by means of an optical electronic device and that the perforation pattern and the first image information are applied on the basis of the digital reproduction of the passport photograph.

In this context, it is also possible that the passport photograph is put into digital form by means of an optical electronic device and that the perforation pattern and the first image information are applied on the basis of the digital reproduction of the passport photograph, and the passport includes a second security feature comprising an engraved pattern which displays a second image information when light falling on the engraved pattern is reflected. As an alternative to the engraved pattern it is also possible to use an inkjet printed pattern as the second security feature or to use a laser printed pattern as the second security feature.

Further, the present invention preferably also relates to a device for performing such a method as mentioned before.

According to a further aspect of the present invention, a forge-proof document comprises the first security feature in the form of a perforation pattern which displays grey tones when viewed against a bright background.

Preferably, the forge-proof document is manufactured from a material which transmits light to a limited extent, wherein preferably the perforation extends over only a part of the thickness of the document at the position of the perforation, and wherein preferably the thickness of the remaining part of the document at the position of the perforation is modulated in accordance with the image and the image information to be displayed.

This measure results in a further degree of difficulty; the determining factor for displaying the grey tone of the perforation, and therewith the image information, is determined by the remaining thickness of the document. This means that the depth of the non-continuous perforation must be determined very precisely. The resulting thickness is, after all, the difference between two larger values, i.e., the thickness of the total document and the depth of the perforation.

It is advantageous that the perforation and the first image information are applied in the forge-proof document from the front and/or from the back side. With this arrangement it is possible, e.g., to easily write the first and second image information on the front or back side with the same laser device.

Advantageously, the perforation extends at an angle differing from 90° relative to the main plane of the forge-proof document. This comprises the result that the perforation cannot be arranged with very small drills, but that use will have to be made of a laser, which on the one hand requires a large investment and on the other requires a high degree of technical knowledge.

Preferably, the angle of perforation is modulated to obtain an image information having a grey-value modulation.

It is a further advantage that there is the possibility, as in the classic straight perforations, to modulate the density or the size and diameter of the perforations of the first security feature in order to generate the first image information.

Advantageously, the perforations and the first image information preferably represent an image.

Preferably, the pattern and the second image information represent an image, a picture, a photo, or a passport photograph. Mentioned terms (image; picture; photo; passport photograph) denote all the same feature, namely the “second image information”.

It is herein noted that the first image information as arranged by means of perforation can be subjected to a certain degree of image-processing. It is hereby possible to compensate the features of the image lost due to the necessary quantization. An example of such an image processing is “contour enhancement”.

The invention is also applicable to perforation patterns which do not represent an image, but which represent an alphanumeric expression or a code.

It will be apparent that a combination of these possibilities can be applied. Such an oblique perforation can of course be combined with a normal straight perforation. This combination provides the option of introducing an extra pattern. The main image, which is modulated in order to display grey tones, is, for instance, arranged herein with a straight perforation, while an additional feature, for instance in the form of a logo or letters, is arranged obliquely. The choice of the angle or other properties of the oblique perforation can be chosen such that during normal observation of the pattern at an angle of about 90°, the normal image appears, and that during observation at another angle, the second image in the form of a logo or a letter combination becomes visible.

Another example is the arranging of two images at the same position on the carrier, although at different angles such that each eye sees its own image, and a stereo image is thus observed.

Preferably, it will be apparent that this can be varied in numerous ways. It is attractive herein to make use of a method wherein the document to be protected is irradiated by a laser source from two positions.

It is of course possible herein to make use of two laser sources, although it is of course simpler to first irradiate the document in a first position with a laser source at a first angle and after that to place the document in a different position wherein it is irradiated by the same laser source at a different angle.

When the laser source is placed close to document, it is also possible to arrange a perforation at an angle differing from 90°; this is caused by the cone or pyramid shape inside which the laser light beam must displace in order to arrange the perforation. A pattern then results which has an increasing angle as the distance to the centre of the image increases.

It is preferred that the cross-section of the perforation in its transverse plane is unequal to a circle. The use of a laser source provides the possibility of performing such a perforation when there is a correct control of the positions of the laser spot. It is, in any case, practically impossible to obtain this with mechanical means in view of the fineness of the required pattern.

Further, it is advantageous that a code is concealed in the representation of the image. Use can be made herein of the teachings already applied in graphic techniques, according to which it is possible to arrange changes in an image which are not visible to the normal eye and which result, after a specific processing, in a code being displayed.

Conversely, an immediately visible coding can also be chosen. The code can be used for instance to identify the machine on which the relevant product was made. The relevant machine can thus be identified in the case of improper use of a machine.

It is also possible that an intermediate layer is arranged in the document, which layer is provided with an ink. The use of laser provides the possibility of complete removal, i.e., burning, evaporating and so on, of the material from which the document is manufactured. Contamination of the relevant layers of the document will herein hardly occur. When such a document is processed with mechanical means, a degree of smearing will occur. This smearing can be observed particularly well when the ink is formed by ink sensitive in UV light.

Advantageously, the ink is visible ink in UV light.

It is preferred that a material is arranged in the perforations.

It is also preferred that perforations arranged in a carrier in a pattern representing an image are filled with an ink which lights up under UV light. Such a pattern becomes visible if it is illuminated with a UV light source.

Preferably, the inner sides of the perforations of such a pattern are provided with a layer, for instance by vapour-deposition of a reflecting metal layer, resulting in an image which is visible when viewed. Selective application of a layer to the inner side of all perforations is possible by arranging a removable foil before the perforations are arranged and removing it after said layer has been applied.

Preferably, the forge-proof document comprises differently coloured material layers, wherein a colour is visible depending on the depth of the perforation.

Advantageously, the starting point is a carrier which is built up of material layers of different colours. By modulating the depth the perforation can be made to end in the desired layer and thereby make a desired colour visible. An image in colour can thus be realized.

It is a further advantage that the forge-proof document is manufactured from plastic laminate and that the core layer has a colour differing from the other layers.

Preferably, the perforation pattern is further provided with perforations modulated in density or size.

It is also possible that the perforation pattern is provided locally with a perforation pattern differing from the rest of the perforation pattern.

It is a further advantage that the perforation pattern is adapted to present a stereo image to the observer from a viewing position.

It is preferred that the perforation pattern is adapted to present, to the person or user, an image which differs per angle of view.

Advantageously, the angle of the perforations to the main plane of the document increase as the distance to the centre of the perforation pattern increases.

Preferably, the cross-section of the perforation pattern in its transverse plane is unequal to a circle.

Advantageously, a code is concealed in the representation of an image.

Preferably, an intermediate layer with an ink is arranged in the carrier. Advantageously, the ink is visible ink in UV light.

It is preferred that the perforation is arranged in a protected element mounted on the carrier, such as an optically variable element.

Further, it is advantageous that the images are personalized.

The invention further provides the option of arranging the perforation in a protected element mounted on the carrier, such as an optically variable element, such as a hologram or a kinegram. Such security features are not accessible to a forger, since they are only transacted between one manufacturer and one buyer. By furthermore providing such a security feature with a personalized perforation pattern, the forger is also deprived of the possibility of transferring such an element from one document to another.

When the image represented by the perforation pattern corresponds with another image arranged on the document, it is possible to have the images coincide. This provides the option of having both images coincide precisely. This has as advantages: the problems for the forger and counterfeiter increase, verification becomes even faster and simpler, and no extra surface area is required for the perforated image.

It is pointed out that the invention preferably also relates to a method for arranging a perforation pattern in a forge-proof document, wherein preferably the perforations are arranged by a laser.

In this context, it is preferred that the forge-proof document is processed in at least two different positions by a laser source.

It is also preferred that the document is processed in a single position from a single laser source.

Advantageously, a foil layer is first arranged on the document, the perforation is subsequently arranged, the document is then subjected to a vapour deposition process and finally the foil is removed.

For the sake of understanding it is noted that the terms “perforation”, “perforation pattern”, “perforated” and “perforated image” all mean the same, namely the first security feature comprising a perforation pattern which displays a first image information when viewed against a bright background.

### BRIEF DESCRIPTION OF THE DRAWINGS

FIG. 1 shows a second security feature of a front side of an inventive forge-proof document;

FIG. 2 shows a second security feature of a back side of the inventive forge-proof document;

FIG. 3 shows a first and second security feature of a front side of the inventive forge-proof document positioned such that light can shine through;

FIG. 4 shows a first and second security feature of a back side of the inventive forge-proof document positioned such that light can shine through;

FIG. 5 shows a schematic perspective view of a device for manufacturing a forge-proof document according to the present invention;

FIG. 6 shows a detail view of a perforation pattern such as illustrated in FIG. 5;

FIG. 7 shows a schematic perspective view of a passport according to the present invention;

FIG. 8 shows a view of a bank note provided with a pattern according to the present invention;

FIG. 9 shows a postage stamp provided with a perforation pattern according to another embodiment of the present invention;

FIG. 10 shows a cross-sectional view of an embodiment of a forge-proof document according to the present invention;

FIG. 11 shows a cross-sectional view of an embodiment of a forge-proof document according to the present invention;

FIG. 12 shows a cross-sectional view of an embodiment of a forge-proof document according to the present invention;

FIG. 13 shows a cross-sectional view of an embodiment of a forge-proof document according to the present invention;

FIG. 14 shows a cross-sectional view of an embodiment of a forge-proof document according to the present invention;

FIG. 15 shows a schematic perspective detail view of an embodiment of the invention;

FIG. 16 shows a schematic perspective detail view of an embodiment of the invention;

FIG. 17 shows a cross-sectional view of an embodiment of the invention, which also serves to elucidate the method used therein; and

FIG. 18 shows a cross-sectional view of an embodiment of the present invention.

### DESCRIPTION OF THE EMBODIMENTS

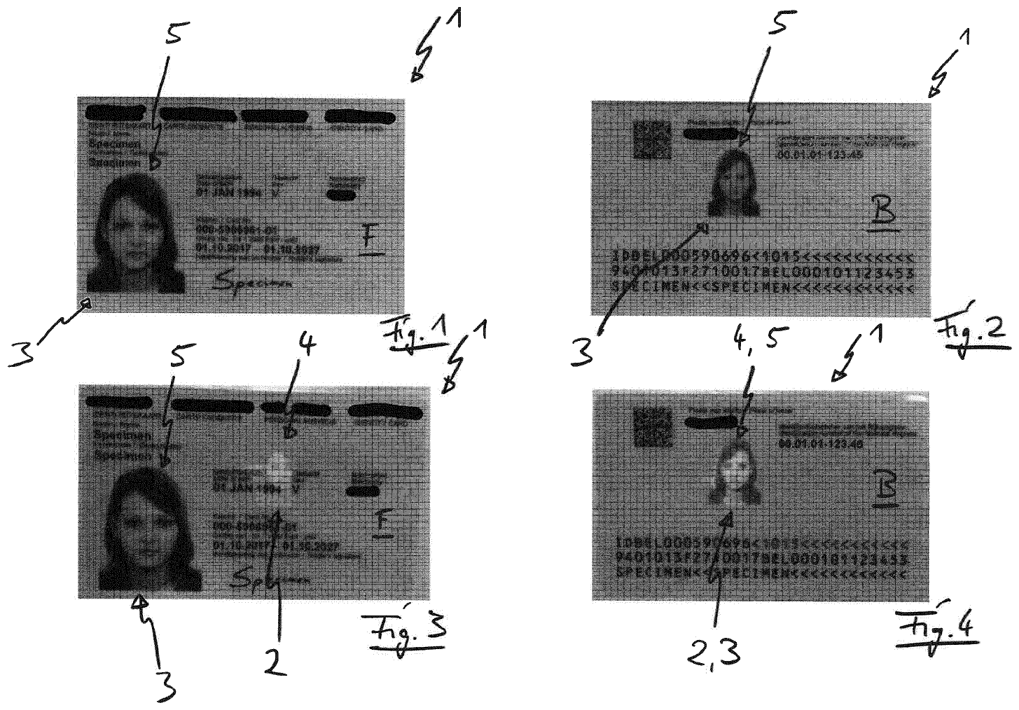

In the following several embodiments of the present invention are explained based on the drawings. It is noticed that the drawings show each a specific embodiment as explained below and further alternative modifications as specified in the description are at least in part not illustrated. However, it is explicitly pointed out that, in particular, the features shown in FIGS. 5 to 18 can be combined with a forge-proof document described in FIGS. 1 to 4.

Further, the same reference signs used in the Figures denote the same components.

In FIG. 1 a second security feature 3 of a front side F of an inventive forge-proof document 1 is shown, wherein FIG. 2 shows a second security feature 3 of a back side B of the inventive forge-proof document 1.

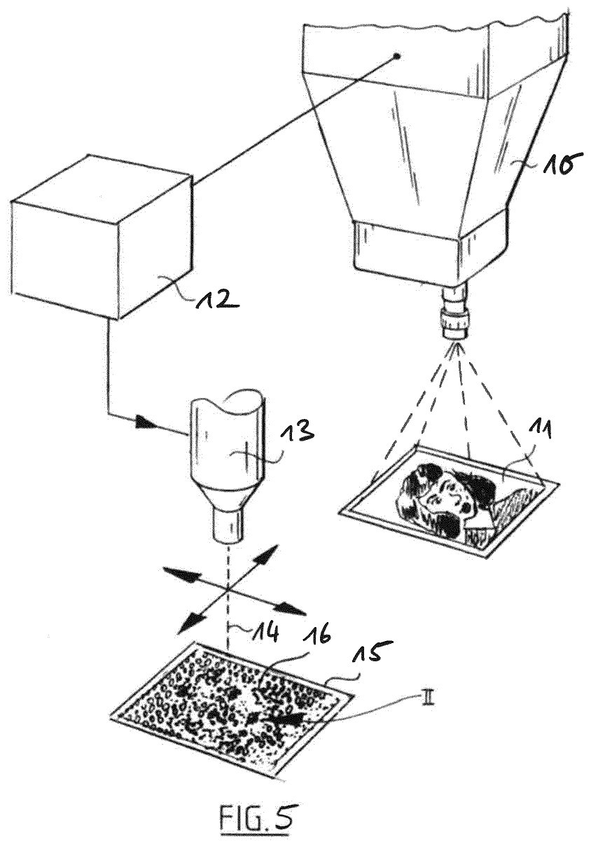

Further, FIG. 3 shows a first and second security feature 2, 3 of the front side F of the inventive forge-proof document 1 positioned such that light can shine through, wherein FIG. 4 shows a first and second security feature 2, 3 of a back side B of the inventive forge-proof document 1 also positioned such that light can shine through.

For the sake of ease and brevity in the following, FIGS. 1 to 4 are described together.

FIGS. 1 to 4 show a forge-proof document 1 having a front side F (FIGS. 1 and 3) and a back side B (FIGS. 2 and 4).

The forge-proof document 1 has a first security feature 2 comprising a perforation pattern 4 which displays a first image information when viewed against a bright background, and a second security feature 3 comprising an engraved pattern 5 which displays a second image information when light falling on the engraved pattern 5 is reflected.

It is noted that the first and second security feature 2, 3 represent an image of a person and a passport photograph, respectively.

It is also noticed that instead of an engraved pattern it is possible to use an inkjet printed pattern as the second security feature or to use a laser printed pattern as the second security feature.

Further, as can be easily seen from FIGS. 1 to 4, the first and the second image information 4, 5 to be displayed on the forge-proof document 1 correspond with each other.

Moreover, the front side F and the back side B comprise the second security feature 3, wherein the second image information 5 of the back side B is the mirrored image information of the second image information 5 of the front side F.

In other words, all the observable first and second image information 4, 5 on the back side B is the horizontally mirrored image information of the observable first and second image information 4, 5 on the front side F (cf. FIGS. 3 and 4).

Further, on the front side F, the second image information 5 represented by the second security feature 3 corresponds to the second image information 5 on the back side B.

Moreover, on the back side B, the second image information 5 represented by the second security feature 3 is identical to the first image information 4 represented by the first security feature 2 (cf. FIG. 4).

And on the back side B, the first and second image information 4, 5 of the corresponding security features 2, 3 coincide as can be seen by comparing FIGS. 2 and 4.

As also can be seen from the FIGS. 1 to 4, the second image information 5 of the front side F comprises a greater size on document 1 than the second image information 5 of the back side B, wherein the size of the second image information 5 on the back side B and the size of the first image information 4 are identical (cf. FIG. 4).

Summarizing the above. As shown in FIGS. 1 to 4 the forge-proof document's front side F comprises the second security feature 3 having an engraved pattern 5 which displays a second image information when light falling on the engraved pattern is reflected.

The back side B comprises the second security feature 3 having an engraved pattern 5 which displays a second image information when light falling on the engraved pattern 5 is reflected.

Further, the forge-proof document 1 comprises—as already mentioned—the first security feature 2 having a perforation pattern which displays a first image information 4 when viewed against a bright background, and the second image information 5 of the front and back sides F, B corresponds to the first image information 4.

Even further, the second image information 5 of the back side B is the mirror image information of the second image information 5 of the front side F.

Referring to all FIGS. 1 to 4, the mentioned figures show that the first security feature 2 in the form of a perforation pattern displays grey tones when viewed against a bright background.

The forge-proof document 1 is manufactured from a material which transmits light to a limited extent, wherein some of the perforations forming part of the perforation pattern extend over only a part of the thickness of the document 1 at the position of the perforation.

Thus, the thickness of the remaining part of the document 1 at the position of the perforation is modulated in accordance with the image to be displayed.

To achieve different grey tones, the density and/or the diameter of the perforations of the first security feature 2 is modulated in order to generate the first image information. An embodiment explaining to achieve these different grey tones will be explained below.

As explained above the first security feature 2 comprises a perforation pattern 4 which displays a first image information when viewed against a bright background, and the second security feature 3 comprises an engraved pattern 5 which displays a second image information when light falling on the engraved pattern 5 is reflected.

However, it is also possible that the front side F of the forge-proof document 1 comprises the second security feature 3 having a pattern of a first printing technique, and the back side B comprises the second security feature 3 having a pattern of a second printing technique.

In such an embodiment, the first and second printing technique differ from each other. This means that the first and second printing techniques comprise laser engraving, inkjet printing or laser printing, wherein in this special embodiment, the first printing technique comprises laser engraving and the second printing technique comprises inkjet printing or laser printing. In other words, the pattern of the second security feature displays a second image information when light falling on the pattern is reflected.

Further, in this special embodiment with two different printing techniques for the second security feature 3 on the front side F and on the back side B, the second image information 5 made by the first printing technique is applied on the front side F and the second image information 5 made by the second printing technique is applied on the back side B.

Further, the second image information 5 corresponds to the first image information 4, wherein the second image information 5 of the back side B is the mirror image information of the second image information 5 of the front side F.

Now reference is made to FIGS. 5 to 9.

Before discussion of the technique shown in FIGS. 5 to 9, it is pointed out that in the present technique, the making of brightness tones, as in the graphic art, is possible by means of perforations which are applied according to a fixed grid, wherein the size of the perforations is a measure for the intensity and that it is also possible to reproduce brightness tones by making use of perforation holes of equal dimensions, wherein the density of these dimensions is a measure for the intensity. Both options can in principle also be combined.

It is pointed out here that in the graphic art the first option is equivalent to the manner in which black and white photographs are reproduced in newspapers and that an example of the second technique can be found in the series of Netherlands postage stamps in which the likeness of Her Majesty the Queen is represented by dots of varying density.

Shown in FIG. 5 is a video camera 10 which is directed at a passport photograph 11. Video camera 10 records the image of passport photograph 11, converts it into an electronic form and feeds the thus obtained signal to a computer 12 in which it is stored.

The device shown in FIG. 5 further comprises a laser beam generating means 13 which is controlled by computer 12. This control relates not only to the intensity and focusing of the laser beam 14 transmitted by laser device 13, but also to the direction in which laser beam 14 is transmitted. It is possible to vary this direction in two planes to apply a perforation pattern 16 and a first security information in a document 15.

It is pointed out here that such laser devices are known in the prior art; in order to change the laser light beam, use is herein made of mirror systems not otherwise shown in FIG. 5. It is also possible to have laser device 13 stand still and to cause a carrier on which document 15 is placed to move. It is also possible to cause the carrier to move in one direction and the laser beam in the other direction; the choice between the various possibilities depends on the technology used. Essential is however that perforation pattern 16 and a first security information comprise perforation holes of differing diameter, wherein the diameter is a function of the brightness to be represented in the image. Perforation holes of differing density can be made by causing the laser beam to generate more or fewer holes locally.

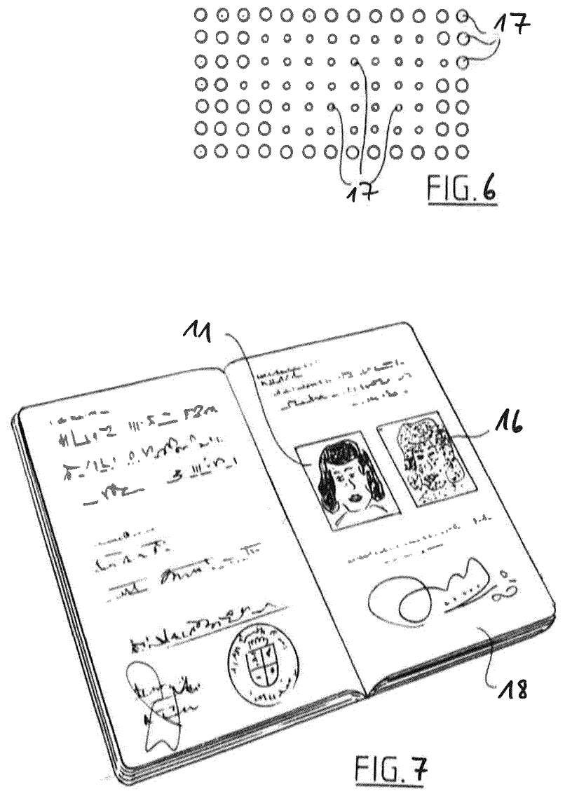

This is illustrated more clearly in FIG. 6, which shows a detail of perforation pattern 16. Herein can be seen that in the present embodiment the perforation pattern is formed by perforation holes 17 which are ordered in a regular grid, for instance a rectangular grid.

The dimension of the holes is herein a measure for the brightness of the image represented by perforation pattern 16, in the present case the passport photograph 11. It is noted here that the dimensions of the perforation holes can be adjusted continuously, thus, in principle, in analog manner; by processing with a digital computer, a finite, yet large, number of stages is however obtained. Tests have demonstrated that it is nevertheless possible to obtain a representation of an image which forms an adequate rendering of the relevant image and can be easily compared therewith. It will be apparent that in this manner a good authenticity feature is obtained which is difficult to copy.

Shown in FIG. 7 is a passport 18 in which the photograph 11 is fixed, for instance by means of glue, tubular rivets or other manner of attachment. On the same page, adjacently thereof, a perforation pattern 16 representing the relevant image is applied. A good comparison can be made by holding up the relevant page of the passport to the light. It is otherwise also possible to apply the perforation pattern on another page of the passport, provided a quick visual comparison is possible. This makes forgery more difficult since at least two different pages must be forged for this purpose. It is also possible to apply the image enlarged, reduced in size or modified in other manner.

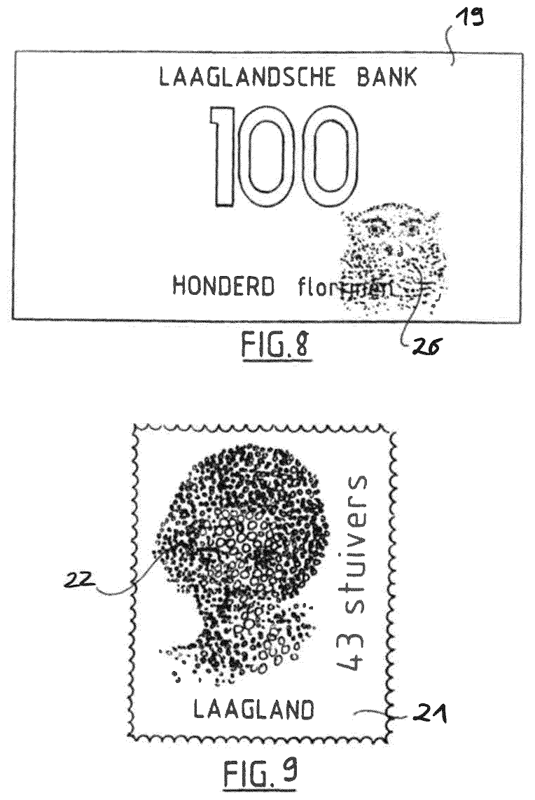

FIG. 8 shows a banknote 19 which is provided with a perforation pattern 20, in the present case in the form of an owl. This perforation pattern is not related to another image arranged on the banknote but forms exclusively a security feature per se; it is possible to provide banknotes with such a security feature. It is again pointed out that the difference with the prior art lies in the fact that the image 20 represents different brightness tones, for instance grey tones. Use is otherwise made herein of a free grid, wherein the dimensions of the perforations are the same and the density of the perforations varies in order to represent the grey tones. The same applies for the postage stamp 21 shown in FIG. 9 which is provided with a perforation pattern 22 in the form of a likeness of Her Majesty the Queen; both forms are herein combined, i.e., a varying grid, wherein the dimensions of the perforations also differ.

Again, it is pointed out that the description of FIGS. 5 to 9 can be applied for the first security feature 2 shown in FIGS. 1 to 4.

Thus, some or all mentioned features of FIGS. 5 to 9 can be incorporated in the embodiment shown in FIGS. 1 to 4.

Now reference is made to FIGS. 10 to 17.

FIG. 10 shows a cross-section of a forge-proof document 1. Document 1 is manufactured from plastic but can likewise be manufactured from another material, such as paper or textile, and it can also be manufactured from laminated material, wherein a combination of diverse material types is made.

This document 1 is provided with perforations. In FIG. 10, the perforations 32 have been arranged. In this embodiment of the present invention, perforations 32 do not extend through the whole thickness of document 1 but leave a part 33 of the document 1 intact.

The remaining parts 33 of the diverse perforations are herein of differing thickness. They therefore transmit light to a greater or lesser extent and, when the document is held against the light, an image comprising grey tones will result subject to the thickness of the remaining part 33 and the depth of perforation 32.

According to an embodiment as shown in FIG. 11, the perforations are arranged obliquely, i.e., at an angle differing from 90° relative to the main plane of the document. It is herein possible to obtain a modulation of the grey tones by varying the relevant angle. This is elucidated with dotted lines in FIG. 11.

It is further possible as shown in FIG. 12 to modulate the width, i.e., the diameter of holes 34. It is of course possible here to combine both forms of modulation. It is moreover possible to combine one of the two modulation forms or both of them with modulation of the density of the perforations. It is of course possible to assign determined properties to such a combination of modulation methods. An example hereof is shown in FIG. 13.

When the document is viewed straight on, as indicated with dotted lines in FIG. 12, a similar grey tone is herein displayed for each of the perforations.

This grey tone can be modulated by varying the density or by varying the size of the perforations. It is herein possible according to the invention to generate an image.

Owing to the fact that both perforations 34 are arranged obliquely, it is possible to provide these perforations with extra information, for instance by arranging them in the form of a letter or a logo. This is of course only visible when the image is viewed at a determined angle.

In the embodiment shown in FIG. 14, a perforation in the form of a cone or in the form of a truncated cone is obtained in both cases. Modulation of the visible grey tone can herein be obtained by varying the “depth” of the cone or its apex angle. This thus forms a combination of depth of hole modulation and diameter of hole modulation. Perforation 40 is thus, for instance, continuous, while perforation 41 is blind.

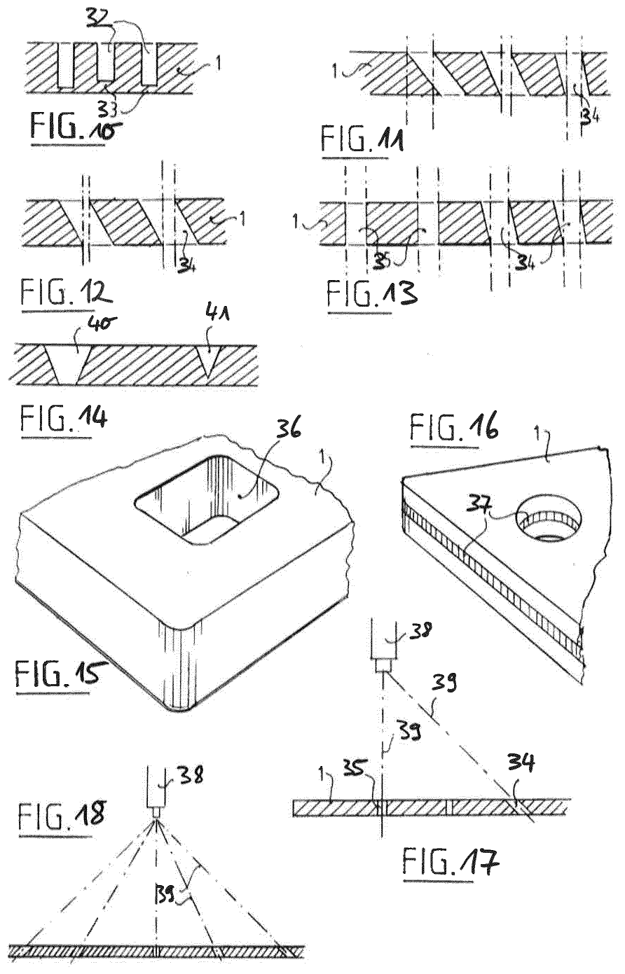

It is further possible, as shown in FIG. 15, to arrange a perforation in a form differing from a circle, for instance a rectangle 36. The rectangular perforation can be difficult to obtain with mechanical means, so that a laser is necessary for this purpose. A laser beam can, after all, be controlled such that it causes a perforation with such a contour, provided the focusing is sufficiently fine. It will be apparent that other shapes are possible, such as triangles, squares, ovals and so on.

FIG. 16 shows a configuration wherein this document is provided with layer 37 provided with ink. This layer is not particularly noticeable when the perforation is arranged with a laser; this layer is also removed by the laser. When an attempt is made to provide such a document with a perforation by means of mechanical means, for instance drilling, the ink will smear, which is clearly visible. Such a configuration can also be applied to laminated cards, the inner layer of which has a colour, for instance white, which differs from the colours of the other layers.

FIG. 17 shows how it is possible, using the same laser light source 38, to provide the same document 1 in different positions with a straight perforation 35 and subsequently with an oblique perforation 34. It is of course essential herein that the laser light beam 39 leaving laser source 38 can be deflected sufficiently. In addition, accurate stops and the like are necessary for the required precision in the positioning of document 1 in the different positions. It will be apparent that it is possible to perforate the document from more than two positions.

Finally, FIG. 18 shows an embodiment wherein laser light source 38 is placed relatively close to document 1, so that as a result of the angular deviation there result perforations which extend at a different angle. It will further be apparent that it is possible within the scope of the present invention to vary in countless ways from the shown embodiments.

Again, it is pointed out that the description of FIGS. 10 to 18 can be applied for the first security feature 2 shown in FIGS. 1 to 4.

Thus, some or all mentioned features of FIGS. 10 to 18 can be incorporated in the embodiment shown in FIGS. 1 to 4.

1. A forge-proof document comprising:
a front side;
a back side;
a first security feature comprising a perforation pattern which displays a first image information when viewed against a bright background; and
a second security feature on each of the front and back sides, the second security feature of each side comprising a pattern which displays a second image information;
wherein the second image information on each of the front and back sides and the first image information correspond with each other; and
wherein the second image information of the back side is mirrored image information of the second image information of the front side.

2. The forge-proof document according to claim 1, herein:
the second security feature on the front side comprises at least one of an engraved pattern, an inkjet printed pattern, or a laser printed pattern; and
the second security feature on the back side comprises at least one of an engraved pattern, an inkjet printed pattern, or a laser printed pattern.

3. (canceled)

4. The forge-proof document according to claim 1, wherein the first image information and the second image information on the back side coincide.

5. (canceled)

6. The forge-proof document according to claim 4, wherein the second image information on the front side coincides with the first image information and the second image information on the back side.

7. The forge-proof document according to claim 1, wherein the second image information on the front side comprises a greater or smaller size on the document than the second image information of on the back side.

8. The forge-proof document according to claim 1, wherein:
the pattern of the second security feature on the front side is made by a first printing technique; and
the pattern of the second security feature on the back side is made by a second printing technique

9. The forge-proof document according to claim 8, wherein:
the first and second printing techniques differ from each other;
the first printing technique comprises laser engraving, inkjet printing, or laser printing; and
the second printing technique comprises laser engraving, inkjet printing, or laser printing.

10. The forge-proof document according to claim 1,
wherein at least some perforations forming the perforation pattern extend over only a part of a thickness of the document, and a thickness of a remaining part of the document at a position of each of the at least some perforations is modulated in accordance with the first image information.

11. The forge-proof document according to claim 1, wherein at least some perforations forming the perforation pattern extend at an angle differing from 90 degrees relative to a main plane of the document, and the angles of the at least some perforations is modulated to obtain a grey-value modulation of the first image information.

12. (canceled)

13. The forge-proof document according to claim 1, wherein material is arranged in at least some perforations of the perforation pattern of the first security feature, and the material is at least one of an ink which lights up under UV light or a vapour-deposited metal layer.

14. The forge-proof document according to claim 1, comprising differently colored material layers, wherein for each perforation of the perforation pattern, a color is visible depending on the depth of the respective perforation.

15. (canceled)

16. The forge-proof document according to claim 1, wherein at least one of a density of perforations or a diameter of perforations for at least some perforations forming the perforation pattern is modulated in order to generate the first image information.

17. The forge-proof document according to claim 1, wherein the document is manufactured from plastic laminate and a core layer of the plastic laminate has a color differing from at least another layer of the plastic laminate.

18. The forge-proof document according to claim 7, wherein a size of the second image information on the back side and a size of the first image information are the same.

19. The forge-proof document according to claim 1, wherein the perforation pattern of the first security feature is configured to present an image which differs by angle of view.

20. The forge-proof document according to claim 1, wherein a cross-section of at least one perforation of the perforation pattern in a transverse plane is non-circular.

21. The forge-proof document according to claim 9, wherein the first printing technique comprises laser engraving and the second printing technique comprises inkjet printing or laser printing.

22. A forge-proof document comprising:
a first side;
a second side;
a first security feature on the first side, the first security feature comprising a pattern that displays first image information; and
a second security feature on the second side, the second security feature comprising a pattern that displays second image information;
wherein the second image information is mirrored image information of the first image information.

23. The forge-proof document according to claim 22, wherein the pattern of the first or second security feature comprises a perforation pattern which displays the first or second image information, respectively, when viewed against a bright background.

24. A method of forming a forge-proof document, the method comprising:
forming a first security feature on a first side of the document, the first security feature comprising a pattern that displays first image information; and
forming a second security feature on a second side of the document, the second security feature comprising a pattern that displays second image information;
wherein the second image information is mirrored image information of the first image information.
